(19) United States
(12) Patent Application Publication
(10) Pub. No.: US 2019/0023868 A1
(43) Pub. Date: Jan. 24, 2019

(54) METHOD OF TREATING THERMOSETTING RESIN CURED PRODUCT

(71) Applicant: HITACHI CHEMICAL COMPANY, LTD., Tokyo (JP)

(72) Inventors: Shunsuke UEDA, Chiyoda-ku, Tokyo (JP); Kanako ISHIHARA, Chiyoda-ku, Tokyo (JP); Keiichi KASUGA, Chiyoda-ku, Tokyo (JP); Ken ORIE, Chiyoda-ku, Tokyo (JP); Kazuhito KOBAYASHI, Chiyoda-ku, Tokyo (JP)

(21) Appl. No.: 15/743,201

(22) PCT Filed: Mar. 8, 2016
(86) PCT No.: PCT/JP2016/057158

§ 371 Date: Jan. 9, 2018

(51) Int. Cl. C08J 11/24; C08J 11/16

(52) U.S. Cl. CPC C08J 11/24; C08J 2363/00; C08J 11/16

(57) ABSTRACT

A method of treating a thermosetting resin cured product, the method includes a treatment step of contacting an object to be treated, that contains a thermosetting resin cured product, with a treatment liquid containing an alkali metal hydroxide and an alcohol solvent, to decompose and dissolve the thermosetting resin cured product, in which moisture in the treatment liquid is removed during at least a part of a period of time from after preparation of the treatment liquid to completion of the treatment step.

### TECHNICAL FIELD

The present invention relates to a method of treating a thermosetting resin cured product.

### BACKGROUND ART

Fiber reinforced plastics (FRPs) using fiber such as glass fiber as a reinforcing material are lightweight, high strength, and high elasticity materials, and are widely used for members of small vessels, automobiles, railroad vehicles, and the like. Carbon fiber reinforced plastics (CFRPs) using carbon fibers as a reinforcing material are developed for the purpose of achieving further lighter weight, higher strength, and higher elasticity, and used for members of aircraft, automobiles, and the like.

CFRP is produced, for example, by impregnating a carbon fiber base material with a thermosetting resin composition and heating the resultant to obtain a prepreg, and then firing the prepreg under pressure in an autoclave.

In a process of producing CFRP in the final shape, a large amount of discards of prepreg and CFRP are produced. A large amount of waste material of CFRP is also generated when disposing a member using CFRP. Therefore, it is desired to recover carbon fibers from CFRP or prepreg, and use them for recycling.

In order to recover carbon fibers from CFRP or prepreg, it is necessary to remove a thermosetting resin cured product. Conventionally, 1) a method of thermally decomposing a thermosetting resin cured product by burning at a high temperature of about from 500° C. to 700° C., 2) a method of decomposing (depolymerizing) and dissolving a thermosetting resin cured product using a treatment liquid, and the like are known as treatment methods for removing a thermosetting resin cured product. In particular, the treatment method 2) has advantages such as less damage to carbon fibers, and a variety of treatment methods have been proposed.

For example, Japanese Patent Application Laid-Open (JP-A) No. 2001-172426 discloses a treatment method for decomposing and dissolving an epoxy resin cured product using a treatment liquid including at least one catalyst selected from the group consisting of an alkali metal, an alkali metal compound, a phosphoric acid, a phosphate, an organic acid, and an organic acid salt and at least one organic solvent selected from the group consisting of an amide solvent, an alcohol solvent, a ketone solvent, and an ether solvent.

JP-A No. 2002-194137 discloses a treatment method for decomposing and dissolving an unsaturated polyester resin cured product using a treatment liquid including at least one phosphoric acid selected from the group consisting of a phosphoric acid, a phosphorous acid, and salts thereof and an organic solvent.

JP-A No. 2003-26853 discloses a treatment method for removing moisture in a treatment solution while decomposing and dissolving an unsaturated polyester resin cured product using a treatment liquid including a phosphoric acid hydrate or a phosphate hydrate and an organic solvent.

JP-A No. 2005-255899 discloses a treatment method for decomposing and dissolving an acid anhydride-cured epoxy resin using a treatment liquid including an alkali metal phosphate from which moisture has been removed and benzyl alcohol.

### SUMMARY OF INVENTION

### Technical Problem

However, in any of conventional treatment methods using a treatment liquid, the decomposition efficiency of a thermosetting resin cured product is not sufficient, and a treatment method with sufficient decomposition efficiency is demanded.

The present disclosure aims to provide a treatment method capable of efficiently decomposing and dissolving a thermosetting resin cured product.

### Solution to Problem

Specific means for solving the above problems includes the following embodiments.

<1> A method of treating a thermosetting resin cured product, the method including a treatment step of contacting an object to be treated, that contains a thermosetting resin cured product, with a treatment liquid containing an alkali metal hydroxide and an alcohol solvent, to decompose and dissolve the thermosetting resin cured product, wherein

moisture in the treatment liquid is removed during at least a part of a period of time from after preparation of the treatment liquid to completion of the treatment step.

<2> The method of treating a thermosetting resin cured product according to <1>, wherein moisture in the treatment liquid is removed before the treatment step.

<3> The method of treating a thermosetting resin cured product according to <1> or <2>, wherein moisture in the treatment liquid is removed in at least a part of a period of time during the treatment step.

<4> The method of treating a thermosetting resin cured product according to any one of <1> to <3>, wherein the thermosetting resin cured product is decomposed and dissolved by immersing the object to be treated in the treatment liquid.

<5> The method of treating a thermosetting resin cured product according to any one of <1> to <4>, wherein the treatment liquid in the treatment step has a temperature of 100° C. or higher.

<6> The method of treating a thermosetting resin cured product according to any one of <1> to <5>, wherein the thermosetting resin cured product includes an epoxy resin cured product.

<7> The method of treating a thermosetting resin cured product according to any one of <1> to <6>, wherein the thermosetting resin cured product includes an acid anhydride-cured epoxy resin.

<8> The method of treating a thermosetting resin cured product according to any one of <1> to <7>, wherein the alkali metal hydroxide includes at least one selected from the group consisting of sodium hydroxide and potassium hydroxide.

<9> The method of treating a thermosetting resin cured product according to any one of <1> to <8>, wherein the alcohol solvent includes a solvent having a boiling point of 105° C. or higher at atmospheric pressure.

<10> The method of treating a thermosetting resin cured product according to any one of <1> to <9>, wherein the alcohol solvent includes benzyl alcohol.

<11> The method of treating a thermosetting resin cured product according to any one of <1> to <10>, wherein the object to be treated further includes an inorganic material.

<12> The method of treating a thermosetting resin cured product according to <11>, wherein the inorganic material includes carbon fibers.

<13> The method of treating a thermosetting resin cured product according to <11> or <12>, further including a step of separating the inorganic material after the thermosetting resin cured product is decomposed and dissolved.

### Advantageous Effects of Invention

According to the disclosure, a treatment method capable of efficiently decomposing and dissolving a thermosetting resin cured product can be provided.

### DESCRIPTION OF EMBODIMENTS

Hereinbelow, embodiments of the present invention are described. However, the present invention is not limited to the following embodiments. In the following embodiments, the constituent elements (including an elemental step or the like) are not always indispensable unless otherwise specified. The same applies to numerical values and ranges thereof, and the invention is not limited thereby.

The term “step” as used herein includes not only a separate step but also a step that is not clearly distinguished from other steps as long as the desired effect of the step is obtained therefrom.

As used herein, the notation “to” expressing a numerical range indicates a range including the numerical values before and after “to”, as the minimum value and the maximum value, respectively.

Regarding numerical ranges described in a stepwise manner, an upper value or a lower value of one numerical range described in a stepwise manner may be replaced with an upper value or a lower value of another numerical range described in a stepwise manner. Regarding a numerical range described herein, an upper value or a lower value of the numerical range may be replaced with a value shown in a working example.

As regard to the amount of a component of a composition, when plural substances corresponding to the same component exist in the composition, the amount of the component in the composition refers to a total amount of the plural substances in the composition unless otherwise specified.

<Method of Treating Thermosetting Resin Cured Product>

A method of treating a thermosetting resin cured product according to the present embodiment (hereinafter, also simply referred to as “treatment method of the present embodiment”) includes a treatment step of contacting an object to be treated, that contains a thermosetting resin cured product, with a treatment liquid containing an alkali metal hydroxide and an alcohol solvent, to decompose and dissolve the thermosetting resin cured product, in which moisture in the treatment liquid is removed during at least a part of a period of time from after preparation of the treatment liquid to completion of the treatment step. Moisture in the treatment liquid may be removed before the treatment step, in at least a part of a period of time during the treatment step, or at both timings. The treatment method of the present embodiment may further include other steps if necessary.

According to the treatment method of the present embodiment, the thermosetting resin cured product can be efficiently decomposed and dissolved. The reason is not necessarily clear, but the present inventors suppose the reason as follows.

For example, when a treatment liquid containing tripotassium phosphate and an alcohol solvent is heated, it is assumed that potassium alkoxide and dipotassium hydrogen phosphate are formed by an exchange reaction between a hydrogen atom of a hydroxyl group of the alcohol solvent and a potassium atom of tripotassium phosphate. When a treatment liquid containing potassium hydroxide and an alcohol solvent is heated, it is assumed that potassium alkoxide and water are formed by an exchange reaction between a hydrogen atom of a hydroxy group of the alcohol solvent and a potassium atom of potassium hydroxide. In other words, when a treatment liquid containing an alkali metal hydroxide and an alcohol solvent is heated, it is assumed that an alkali metal alkoxide and water are generated. In such cases, by lowering the moisture content in the treatment liquid, the reaction of forming the alkali metal alkoxide is promoted.

An alkali metal alkoxide decomposes a thermosetting resin cured product by cutting an ester bonding portion and the like in the thermosetting resin cured product. Since alkali metal hydroxide has stronger basicity than alkali metal phosphate, in a case in which equivalent molar amounts thereof are used, the amount of the alkali metal alkoxide produced is larger than the amount of the alkali metal phosphate. Therefore, an alkali metal hydroxide has a good catalytic activity in decomposing a thermosetting resin cured product as compared with an alkali metal phosphate such as tripotassium phosphate. An alcohol solvent has good solubility of a decomposition product obtained by decomposing a thermosetting resin cured product.

In a case in which moisture generated upon heating a treatment liquid containing an alkali metal hydroxide and an alcohol solvent is not removed, the amount of the alkali metal alkoxide produced does not increase due to the moisture, whereby the decomposition efficiency of a thermosetting resin cured product is lowered.

In the treatment method of the present embodiment, since moisture in the treatment liquid is removed during at least a part of a period of time from after preparation of the treatment liquid to completion of the treatment step, it is assumed that the thermosetting resin cured product can be efficiently decomposed and dissolved.

In the following, first, a method of removing a treatment liquid and moisture used in the treatment method of the present embodiment is described, and then an object to be treated and the treatment method are described.

Treatment Liquid

The treatment liquid used in the treatment method of the present embodiment includes an alkali metal hydroxide and an alcohol solvent. The treatment liquid may further include another component if necessary.

Examples of the alkali metal hydroxide include hydroxides of an alkali metal such as lithium, sodium, potassium, rubidium, or cesium. The alkali metal hydroxide may be used singly, or in combination of two or more kinds thereof.

From the viewpoints of favorable dissolvability in an alcohol solvent, high catalytic activity (ionic activity), low molecular weight and low price per unit weight, and the like, the alkali metal hydroxide preferably contains at least one selected from the group consisting of sodium hydroxide and potassium hydroxide, and more preferably contains sodium hydroxide.

From the viewpoint of further improving the decomposition efficiency of the thermosetting resin cured product, the content of the alkali metal hydroxide in the treatment liquid as the total amount with respect to 1,000 g of the alcohol solvent is preferably 0.01 mol or more, more preferably 0.10 mol or more, and still more preferably 0.30 mol or more. From the viewpoints of increasing the dissolvability of the decomposition product and facilitating the preparation of the treatment liquid, the content of the alkali metal hydroxide in the treatment liquid as the total amount with respect to 1,000 g of the alcohol solvent is preferably 10.00 mol or less, more preferably 5.00 mol or less, still more preferably 3.00 mol or less, and even more preferably 1.00 mol or less.

The alkali metal hydroxide may be mixed with the alcohol solvent in a solid state and may be mixed with the alcohol solvent in a form of an aqueous solution. Since the alkali metal hydroxide has hygroscopicity and deliquescency, in a case in which an alkali metal hydroxide is used in a solid state, in order to lower the moisture content of a treatment liquid, the alkali metal hydroxide is preferably dried sufficiently and then mixed with the alcohol solvent. In a case in which the alkali metal hydroxide is used in a form of an aqueous solution, the concentration of the aqueous solution is preferably 10% by mass or more, and more preferably 20% by mass or more. In a case in which the aqueous solution having a high concentration of 10% by mass or more is used, the amount of moisture to be removed from the treatment liquid can be reduced.

The alcohol solvent is not particularly limited, and examples thereof include 1-butanol, 2-butanol, 2-methyl-1-propanol, 2-methyl-2-propanol, 1-pentanol, 2-pentanol, 3-pentanol, 2-methyl-1-butanol, 2-methyl-2-butanol, 3-methyl-1-butanol, 3-methyl-2-butanol, 2,2-dimethyl-1-propanol, 1-hexanol, 2-hexanol, 3-hexanol, 2-methyl-1-pentanol, 4-methyl-2-pentanol, 2-ethyl-1-butanol, 1-heptanol, 2-heptanol, 3-heptanol, 2-ethyl hexanol, dodecanol, cyclohexanol, 1-methyl cyclohexanol, 2-methyl cyclohexanol, 3-methyl cyclohexanol, 4-methyl cyclohexanol, benzyl alcohol, phenoxy ethanol, 1-(2-hydroxyethyl)-2-pyrrolidone, diacetone alcohol, ethylene glycol, ethylene glycol monomethyl ether, ethylene glycol monoethyl ether, ethylene glycol monopropyl ether, ethylene glycol monobutyl ether, diethylene glycol, diethylene glycol monomethyl ether, diethylene glycol monoethyl ether, diethylene glycol monopropyl ether, diethylene glycol monobutyl ether, triethylene glycol, triethylene glycol monomethyl ether, triethylene glycol monoethyl ether, tetraethylene glycol, polyethylene glycol (molecular weight: from 200 to 400), 1,2-propanediol, 1,3-propanediol, 1,2-butanediol, 1,3-butanediol, 1,4-butanediol, 2,3-butanediol, 1,5-pentane diol, glycerin, and dipropylene glycol. The alcohol solvent may be used singly, or two or more kinds thereof may be used in combination.

From the viewpoint of removing moisture from the treatment liquid, the alcohol solvent preferably contains a solvent having a boiling point at atmospheric pressure higher than the boiling point of water (hereinafter, also referred to as “high boiling point solvent”). From the viewpoint of enhancing the separation accuracy from moisture, the boiling point of the high boiling point solvent at atmospheric pressure is preferably 105° C. or higher, more preferably 130° C. or higher, and still more preferably 150° C. or higher. From the viewpoint of the dissolvability of the decomposed product, it is preferable that the alcohol solvent includes benzyl alcohol.

The treatment liquid may further include another component if necessary. Examples of the other component include a surfactant and a low viscosity solvent.

From the viewpoint of further improving the decomposition efficiency of the thermosetting resin cured product, it is preferable that the treatment liquid contains the alkali metal hydroxide including at least one selected from the group consisting of sodium hydroxide and potassium hydroxide and the alcohol solvent including benzyl alcohol. It is more preferable that the treatment liquid has a total content of at least one selected from the group consisting of sodium hydroxide and potassium hydroxide of from 0.01 mol to 3.00 mol in 1,000 g of the alcohol solvent.

Method of Removing Moisture in Treatment Liquid

The method of removing moisture in the treatment liquid is not particularly limited, and moisture may be removed by volatilizing moisture under atmospheric pressure or may be removed by volatilizing moisture under reduced pressure. From the viewpoint of simplifying a treatment equipment, moisture is preferably volatilized under atmospheric pressure. In a case in which moisture in the treatment liquid is removed, the thermosetting resin cured product can be more efficiently decomposed and dissolved. Moisture may be removed during at least a part of a period of time from after preparation of the treatment liquid to completion of the treatment step, and removal of moisture in the treatment liquid may be performed before the treatment step, in at least a part of a period of time during the treatment step, or at both timings. In a case in which moisture removal is performed in at least a part of a period of time during the treatment step, it is preferable that moisture is removed throughout a period of time during the treatment step from the viewpoint of more efficiently decomposing and dissolving a thermosetting resin cured product.

[Moisture Removal by Heating]

An example of a method of removing moisture in the treatment liquid includes heating the treatment liquid. In a case in which the treatment liquid is heated, the vapor pressure of moisture in the treatment liquid increases, and the removal of moisture from the treatment liquid surface is promoted. In particular, in a case in which the treatment liquid containing the alkali metal hydroxide and the alcohol solvent is heated, the reaction of forming an alkali metal alkoxide can be accelerated.

The heating temperature of the treatment liquid can be appropriately set according to the kinds of the alkali metal hydroxide and the alcohol solvent. The heating temperature of the treatment liquid is preferably, for example, 100° C. or higher, and more preferably 110° C. or higher. In a case in which the heating temperature of the treatment liquid is set to 100° C. or higher, the reaction between the alkali metal hydroxide and the alcohol solvent proceeds sufficiently, and a practical decomposition efficiency tends to be obtained. The heating temperature of the treatment liquid is preferably lower than the boiling point of the alcohol solvent.

The method of heating the treatment liquid is not particularly limited. For example, the treatment liquid may be directly heated with a heater, or a container containing the treatment liquid may be indirectly heated with a heater. For example, the treatment liquid may be heated using a heating medium such as oil, water, or steam.

[Moisture Removal by Bubbling]

Another example of the method of removing moisture in the treatment liquid includes bubbling. By bubbling the treatment liquid, moisture in the treatment liquid becomes water vapor and is easily discharged from the solution. By performing bubbling while heating the treatment liquid, moisture can be removed more efficiently.

The gas used for bubbling is not particularly limited and may be atmospheric air or an inert gas such as nitrogen, argon, or carbon dioxide. When bubbling is performed while heating the treatment liquid, an inert gas is preferably used in consideration of reactivity or the like.

[Cooling of Steam]

In the method of heating the treatment liquid to remove moisture from the treatment liquid, not only moisture but also a part of the alcohol solvent volatilizes. Therefore, the steam generated by heating may be cooled to liquefy the volatilized alcohol solvent. By cooling the steam to a temperature at which dew condensation of only water vapor is difficult, reduction of alcohol solvent can be suppressed by utilizing the difference in boiling points between the alcohol solvent and water.

The cooling temperature of the steam can be appropriately set according to the kind of the alcohol solvent, the gas flow rate when bubbling, or the like. The cooling temperature of the steam is preferably, for example, from 20° C. to less than 190° C., and more preferably from 60° C. to less than 170° C. In a case in which the cooling temperature of steam is set to 20° C. or higher, the vapor pressure of moisture is increased, and the water removal efficiency is further improved. In a case in which the cooling temperature of the steam is set to less than 190° C., the decrease of the alcohol solvent can be further suppressed.

[Evaluation Method of Moisture Content]

The moisture content in the treatment liquid can be evaluated by, for example, the Karl Fischer method. From the viewpoint of suppressing a large decrease in the boiling point of the treatment liquid, the moisture content in the treatment liquid is preferably less than 3% by mass, and from the viewpoint of decomposing and dissolving the thermosetting resin cured product more efficiently, the water content in the treatment liquid is more preferably less than 1% by mass, and still more preferably less than 0.5% by mass.

Object to be Treated

An object to be treated in the treatment method of the present embodiment includes a thermosetting resin cured product. Examples of the thermosetting resin cured product include a cured product of a thermosetting resin such as an epoxy resin, an unsaturated polyester resin, a polyimide resin, a polyamide resin, a polyamideimide resin, a phenol resin, or a melamine resin. The thermosetting resin cured product may be used singly, or two or more kinds thereof may be used in combination. From the viewpoint of further improving the decomposition efficiency by the treatment liquid, the thermosetting resin cured product preferably contains at least one selected from the group consisting of an epoxy resin cured product and an unsaturated polyester resin cured product, and more preferably contains an epoxy resin cured product.

The object to be treated may contain a thermoplastic resin other than the thermosetting resin cured product. Examples of the thermoplastic resin include a polyethylene resin, a polypropylene resin, a polyvinyl chloride resin, a polyvinylidene chloride resin, a polystyrene resin, a polyvinyl acetate resin, a polyurethane resin, a polycarbonate resin, a polyacetal resin, and a polyethylene terephthalate resin. The thermoplastic resin may be used singly, or two or more kinds thereof may be used in combination.

The object to be treated is obtained, for example, by heating a thermosetting resin composition containing a thermosetting resin and curing at least a part of the thermosetting resin. The object to be treated may contain an uncured thermosetting resin.

In a case in which the object to be processed contains an epoxy resin cured product, the object to be treated is obtained, for example, by heating a thermosetting resin composition containing an epoxy resin, a curing agent and, if necessary, a curing accelerator, and curing at least a part of the epoxy resin.

Examples of the epoxy resin include a bisphenol A epoxy resin, a bisphenol F epoxy resin, a bisphenol S epoxy resin, an alicyclic epoxy resin, an aliphatic chain epoxy resin, a phenol novolac epoxy resin, a cresol novolac epoxy resin, a bisphenol A novolac epoxy resin, a diglycidyl etherified product of biphenol, a diglycidyl ether compound of naphthalene diol, a diglycidyl ether compound of a phenol compound, and a diglycidyl ether compound of an alcohol compound, and an alkyl substituted product thereof, a halide thereof, and a hydrogenated product thereof. The epoxy resin may be used singly, or two or more kinds thereof may be used in combination.

Examples of the curing agent include an acid anhydride, an amine compound, a phenol compound, and an isocyanate compound. The curing agent may be used singly, or two or more kinds thereof may be used in combination. Among these, the curing agent is preferably an acid anhydride. In other words, the object to be treated preferably contains an acid anhydride-cured epoxy resin. The acid anhydride-cured epoxy resin has an ester bond in the molecule, and can be more efficiently decomposed using the above-described treatment liquid.

Examples of the acid anhydride include phthalic anhydride, tetrahydrophthalic anhydride, hexahydrophthalic anhydride, methyltetrahydrophthalic anhydride, methylhexahydrophthalic anhydride, methylnadic anhydride, succinic anhydride, dodecylsuccinic anhydride, chlorenedic anhydride, itaconic anhydride, maleic anhydride, pyromellitic anhydride, trimellitic anhydride, benzophenonetetracarboxylic dianhydride, ethylene glycol bistrimellitate dianhydride, glycerol tris-trimellitate trianhydride, polyadipic acid anhydride, polyazelaic acid anhydride, and polysebacic acid anhydride. The acid anhydride may be used singly, or two or more kinds thereof may be used in combination.

Examples of the curing accelerator include an imidazole compound, a tertiary amine compound, a quaternary ammonium salt, and an organic phosphorus compound. The curing accelerator may be used singly, or two or more kinds thereof may be used in combination.

It is preferable that the object to be treated further includes an inorganic material. Examples of the inorganic material include carbon, glass, a metal, and a metal compound. Examples of the shape of the inorganic material include fibers, particles, and foil. The fibers may be in the form of a nonwoven fabric or a woven fabric. In the case of the woven fabric, the woven fabric may be a cloth material made by weaving a fiber bundle, or a uni-directional (UD) material in which fiber bundles are arranged in one direction. The inorganic material may be used singly, or two or more kinds thereof may be used in combination.

Among inorganic materials, the object to be treated preferably includes carbon fibers. In a case in which the object to be treated is treated by the treatment method of the present embodiment, carbon fibers contained in the object to be treated can be recovered and used for recycling. The carbon fibers may be made of an acrylic resin as a raw material, or may be made of pitch as a raw material.

The object to be treated containing carbon fibers is obtained by, for example, impregnating a carbon fiber base material with a thermosetting resin composition and heating the resultant. The object to be treated containing carbon fibers may be a prepreg in a B-stage state in which a thermosetting resin is semi-cured, or a cured body in a C-stage state (CFRP) in which a thermosetting resin is cured.

The size of the object to be treated is not particularly limited, and may be adjusted to a size that can be treated according to the scale of a treatment device. From the viewpoint of shortening the treatment time, the object to be treated is preferably as small as possible. In a case in which the object to be treated contains an inorganic material such as carbon fibers, from the viewpoint of recycling the recovered inorganic material, the object to be treated is preferably large. In one embodiment, the size of the object to be treated is adjusted to a range of from 0.1 cm³ to 1.5 m³. When the object to be treated containing carbon fibers is cut into small pieces, the recovered carbon fibers can be used, for example, for manufacturing a nonwoven fabric.

Treatment Method

The treatment method of the present embodiment includes a treatment step of contacting the object to be treated, that contains the thermosetting resin cured product with the above-described treatment liquid, to decompose and dissolve the thermosetting resin cured product. Moisture in the treatment liquid may be removed in at least a part of a period of time during this treatment step.

The method of decomposing and dissolving the thermosetting resin cured product using the treatment liquid is not particularly limited, and the object to be treated may be immersed in the treatment liquid, or the treatment liquid may be sprayed onto the object to be treated by spraying or the like. From the viewpoint of more efficiently decomposing and dissolving the thermosetting resin cured product, the object to be treated is preferably immersed in the treatment liquid.

In one embodiment, the object to be treated is immersed in the treatment liquid in a container, and if necessary, the treatment liquid is agitated to decompose and dissolve the cured product of the thermosetting resin. The stirring method is not particularly limited, and examples thereof include a method using an agitating blade, a method of generating a jet flow, a method of swinging a container, a method of generating bubbles of an inert gas, and a method of applying ultrasonic waves.

The atmosphere at the time of decomposing and dissolving the thermosetting resin cured product using the treatment liquid is not particularly limited, and the atmosphere may be an air atmosphere or an inert gas atmosphere such as nitrogen or argon.

In a case in which the object to be treated contains an inorganic material, the treatment method of the present embodiment preferably further includes a separation step of separating the inorganic material after the thermosetting resin cured product is decomposed and dissolved.

The inorganic material can be separated from the treatment liquid, for example, by filtering the treatment liquid after decomposing and dissolving the thermosetting resin cured product. The inorganic material recovered through the separation step can be recycled.

### EXAMPLES

Hereinafter, the invention is described more specifically by way of Examples and Comparative Examples. However, the invention is not limited to these examples.

### Example 1

### [Preparation of Test Piece]

TORAYCA (registered trademark) prepreg (manufactured by Toray Industries, Inc.) using TORAYCA (registered trademark) T300 (manufactured by Toray Industries, Inc.) as a carbon fiber was cut into a size of 10 mm×40 mm to prepare a test piece.

[Preparation of Treatment Liquid]

10 g of benzyl alcohol (BZA) and 0.02 mol (0.8 g) of sodium hydroxide as a catalyst at a ratio of 2.00 mol of sodium hydroxide per 1,000 g of benzyl alcohol were respectively weighed into a test tube, and the mixture was heated using an oil bath to a temperature in the test tube of 190° C.±2° C. while gently stirring with a spatula from the bottom of the test tube. As a result, moisture was generated in the form of bubbles in the range of from 100° C. to 190° C. By continuing heating, moisture was discharged into the atmosphere, whereby a treatment liquid was prepared.

A part of the prepared treatment liquid was sampled, and the sodium concentration was measured using an atomic absorption photometer (manufactured by Hitachi High-Tech Science Corporation), which was 2.0 mol/kg. A part of the treatment liquid was sampled, and the water concentration was measured using a Karl Fischer moisture meter (MKC-610, manufactured by Kyoto Electronics Manufacturing Co., Ltd.), which was 0.125% by mass.

[Decomposition and Dissolution of Test Piece]

When the temperature of the treatment liquid reached 190° C.±2° C., 2.0 g of the test piece was gently added and the mixture was treated for 1 hour while maintaining the temperature of the treatment liquid at 190° C.±2° C. under atmospheric atmosphere and atmospheric pressure. The test tube was then taken out and immersed in ice water and cooled. After cooling the test tube to room temperature (25° C.) or lower, the treatment liquid and the dissolution residue after the treatment were placed in a glass funnel, and the treatment liquid and the dissolution residue were separated by suction filtration. On the glass funnel, the dissolution residue was washed sequentially with 20 mL of benzyl alcohol and 20 mL of water. After the washing, the dissolution residue was taken in a stainless steel petri dish, heated and dried sequentially at 0° C. for 30 minutes, at 110° C. for 30 minutes, at 170° C. for 30 minutes, and at 210° C. for 60 minutes in a thermostatic chamber, and the dissolution residue was recovered.

Then, the dissolving rate (%) of the test piece was calculated according to the following formula. As a result, the dissolving rate of the test piece was 42.7%.

Dissolving rate (%) of test piece=100×(mass of test piece before treatment−mass of dissolution residue after treatment)/mass of test piece before treatment

### Example 2

A treatment liquid was prepared in the same manner as in Example 1 except that 10 g of 1,4-butanediol (BDO) was used instead of 10 g of benzyl alcohol (BZA). Using the prepared treatment liquid, the test piece was treated in the same manner as in Example 1. As a result, the dissolving rate of the test piece was 42.8%.

### Example 3

A treatment liquid was prepared in the same manner as in Example 1 except that 0.02 mol (1.12 g) of potassium hydroxide was used instead of 0.02 mol (0.8 g) of sodium hydroxide. Using the prepared treatment liquid, the test piece was treated in the same manner as in Example 1. As a result, the dissolving rate of the test piece was 43.5%.

### Example 4

A treatment liquid was prepared in the same manner as in Example 1 except that 10 g of 1,4-butanediol (BDO) was used instead of 10 g of benzyl alcohol (BZA) and potassium hydroxide (1.12 g) was used instead of sodium hydroxide (0.8 g). Using the prepared treatment liquid, the test piece was treated in the same manner as in Example 1. As a result, the dissolving rate of the test piece was 43.5%.

### Comparative Example 1

A treatment liquid was prepared in the same manner as in Example 1 except that sufficiently dried 0.02 mol (4.25 g) of tripotassium phosphate was used instead of 0.02 mol (0.8 g) of sodium hydroxide. Using the prepared treatment liquid, the test piece was treated in the same manner as in Example 1. Since no moisture was generated during the temperature raising process, moisture was not removed. As a result, the dissolving rate of the test piece was 41.7%.

### Example 5

### [Production of Test Piece]

215.5 g of bisphenol A epoxy resin (YD-8125, manufactured by NIPPON STEEL & SUMIKIN CHEMICAL CO., LTD., epoxy equivalent: 172.4 g/eq), 53.2 g of isophorone diamine (manufactured by Tokyo Chemical Industry Co., Ltd., active hydrogen equivalent: 42.6 g/eq) as a curing agent, and 2.04 g of 1-cyanoethyl-2-ethyl-4-methylimidazole (2E4MZ-CN, manufactured by Shikoku Chemicals Corporation) as a curing accelerator were weighed into a mortar, heated to 60° C., and then stirred using a pestle for about 3 minutes and mixed. 50.0 g each of the obtained epoxy resin composition was weighed into five aluminum cups with a bottom diameter of 130 mm. The aluminum cups were arranged in a stainless steel vat, and heated sequentially at 80° C. for 30 minutes and at 150° C. for 60 minutes in a constant temperature bath while each covered with a stainless steel lid with holes and maintained horizontal. After the heating, the aluminum cups were taken out from the vat while hot, and they were placed on a surface plate at room temperature (25° C.) and quenched. After cooling to room temperature (25° C.), the aluminum cups was peeled off to obtain a plate of an epoxy resin cured product (EP resin plate) having a thickness of a 3 mm. The EP resin plate was cut into 40 mm×10 mm to prepare a test piece.

[Decomposition and Dissolution of Test Piece]

In order to remove volatile components such as moisture contained in each test piece, the test piece was dried at 110° C. for 3.0 hours using a constant temperature bath. Next, 1.0 g of the test piece was weighed and charged into a 50 mL test tube.

10 g of benzyl alcohol (BZA) and 0.02 mol (0.8 g) of sodium hydroxide as a catalyst at a ratio of 2.00 mol of sodium hydroxide per 1,000 g of benzyl alcohol were respectively weighed and added into the test tube. Thereafter, the test tube was put in an oil bath adjusted to 150° C. and the temperature of the oil bath was raised while stirring using a spatula for about 1 minute every about 10 minutes, and the temperature thereof was raised to 190° C. over 1.0 hour. After the temperature of the treatment liquid reached 190° C., stirring was carried out using a spatula for about 1 minute every about 30 minutes. Bubbles of water generated during the process of raising the temperature of the treatment liquid were discharged into the atmosphere. The test piece was treated for 10 hours while removing the moisture in the treatment liquid by maintaining the temperature of the treatment liquid at 190° C. under atmospheric atmosphere and atmospheric pressure.

The test tube was then taken out and immersed in ice water and cooled. After cooling the test tube to room temperature (25° C.) or lower, the treatment liquid and the dissolution residue after the treatment were placed in a glass funnel, and the treatment liquid and the dissolution residue were separated by suction filtration. On the glass funnel, the dissolution residue was washed sequentially with 20 mL of benzyl alcohol and 20 mL of water. After the washing, the dissolution residue was taken in a stainless steel petri dish, heated and dried sequentially at 0° C. for 30 minutes, at 110° C. for 30 minutes, at 170° C. for 30 minutes, and at 210° C. for 60 minutes in a thermostatic chamber, and the dissolution residue was recovered.

Then, the dissolving rate (%) of the test piece was calculated according to the following formula. As a result, the dissolving rate of the test piece was 100%.

Dissolving rate (%) of test piece=100×(mass of test piece before treatment−mass of dissolution residue after treatment)/mass of test piece before treatment

### Example 6

A test piece was treated in the same manner as in Example 5 except that 10 g of tetraethylene glycol (TEG) was used instead of 10 g of benzyl alcohol (BZA), and the treatment temperature was set at 220° C. instead of 190° C. As a result, the dissolving rate of the test piece was 100%.

### Example 7

A test piece was treated in the same manner as in Example 5 except that 10 g of 1,4-butanediol (BDO) was used instead of 10 g of benzyl alcohol (BZA), and the treatment temperature was set at 220° C. instead of 190° C. As a result, the dissolving rate of the test piece was 100%.

### Comparative Example 2

A test piece was prepared in the same manner as in Example 5 except that sufficiently dried 0.02 mol (3.28 g) of trisodium phosphate was used instead of 0.02 mol (0.8 g) of sodium hydroxide. Since no moisture was generated during the temperature raising process, moisture was not removed. As a result, the dissolving rate of the test piece was less than 1%.

### Example 9

### [Preparation of Test Piece]

TORAYCA (registered trademark) prepreg (manufactured by Toray Industries, Inc.) using TORAYCA (registered trademark) T300 (manufactured by Toray Industries, Inc.) as a carbon fiber was cut into a size of 5 mm×40 mm to prepare a test piece.

[Decomposition and Dissolution of Test Piece]

1.2 g of the test piece was placed in a sealable 10 mL SUS container. Then, 6 g of benzyl alcohol (BZA) and 0.003 mol (0.12 g) of sodium hydroxide as a catalyst at a ratio of 0.50 mol of sodium hydroxide per 1,000 g of benzyl alcohol were respectively weighed and charged thereto. Thereafter, the SUS container was put in an explosion-proof dryer heated to 190° C. in a non-sealed state, and moisture in a treatment liquid was removed until the temperature of the treatment liquid reached 190° C. Then, the SUS container was left for 1 hour starting at the time when the internal temperature reached 190° C.±2° C., and the dissolution treatment was continuously carried out.

The SUS container was then taken out and immersed in ice water and cooled. After cooling the SUS container to room temperature (25° C.) or lower, the treatment liquid and the dissolution residue after the treatment were placed in a glass funnel, and the treatment liquid and the dissolution residue were separated by suction filtration. On the glass funnel, the dissolution residue was washed sequentially with 20 mL of benzyl alcohol and 20 mL of water. After the washing, the dissolution residue was taken in a stainless steel petri dish, heated and dried sequentially at 0° C. for 30 minutes, at 110° C. for 30 minutes, at 170° C. for 30 minutes, and at 210° C. for 60 minutes in a thermostatic chamber, and the dissolution residue was recovered.

Then, the dissolving rate (%) of the test piece was calculated according to the following formula. As a result, the dissolving rate of the test piece was 43.2%.

Dissolving rate (%) of test piece=100×(mass of test piece before treatment−mass of dissolution residue after treatment)/mass of test piece before treatment

### Comparative Example 3

A test piece was treated in the same manner as in Example 8 except that, instead of placing the SUS container into the explosion-proof dryer in a non-sealed state, the SUS container was placed in the explosion-proof dryer in a sealed state. Due to the sealing of the SUS container, the generated moisture was not removed and stayed in the container. As a result, the dissolving rate of the test piece was 41.6%.

The results of Examples 1 to 8 and Comparative Examples 1 to 3 are summarized in the following Table 1.

TABLE 1

| | | | Absence or | | |
|---|---|---|---|---|---|
| | | | presence of | Object | |
| | Catalyst | | moisture | to be | Dissolving |
| | (mol/kg) | Solvent | removal | treated | rate |
| Example 1 | NaOH | BZA | Present | Prepreg | 42.7% |
| | (2.00) | | | | |
| Example 2 | NaOH | BDO | Present | Prepreg | 42.8% |
| | (2.00) | | | | |
| Example 3 | KOH | BZA | Present | Prepreg | 43.5% |
| | (2.00) | | | | |
| Example 4 | KOH | BDO | Present | Prepreg | 43.5% |
| | (2.00) | | | | |
| Example 5 | NaOH | BZA | Present | EP resin | 100% |
| | (2.00) | | | plate | |
| Example 6 | NaOH | TEG | Present | EP resin | 100% |
| | (2.00) | | | plate | |
| Example 7 | NaOH | BDO | Present | EP resin | 100% |
| | (2.00) | | | plate | |
| Example 8 | NaOH | BZA | Present | Prepreg | 43.2% |
| | (0.50) | | | | |
| Comparative | K₃PO₄ | BZA | Absent | Prepreg | 41.7% |
| Example 1 | (2.00) | | | | |
| Comparative | Na₃PO₄ | BZA | Absent | EP resin | less |
| Example 2 | (2.00) | | | plate | than 1% |
| Comparative | NaOH | BZA | Absent | Prepreg | 41.6% |
| Example 3 | (0.50) | | | | |

As can be seen from Table 1, in each of Examples 1 to 8 in which a treatment liquid containing an alkali metal hydroxide and an alcohol solvent was used and moisture in the treatment liquid was removed, the dissolving rate of a test piece was increased compared with each of Comparative Examples 1 and 2 in which an alkali metal phosphate was used instead of an alkali metal hydroxide and moisture in the treatment liquid was not removed and Comparative Example 3 in which a treatment liquid containing an alkali metal hydroxide and an alcohol solvent was used but moisture in the treatment liquid was not removed.

All documents, patent applications, and technical standards described in the present specification are incorporated herein by reference to the same extent as if each individual document, patent application, and technical standard were specifically and individually indicated to be incorporated by reference.

1. A method of treating a thermosetting resin cured product, the method comprising a treatment step of contacting an object to be treated, that contains a thermosetting resin cured product, with a treatment liquid containing an alkali metal hydroxide and an alcohol solvent, to decompose and dissolve the thermosetting resin cured product, wherein
moisture in the treatment liquid is removed during at least a part of a period of time from after preparation of the treatment liquid to completion of the treatment step.

2. The method of treating a thermosetting resin cured product according to claim 1, wherein moisture in the treatment liquid is removed before the treatment step.

3. The method of treating a thermosetting resin cured product according to claim 1, wherein moisture in the treatment liquid is removed in at least a part of a period of time during the treatment step.

4. The method of treating a thermosetting resin cured product according to claim 1, wherein the thermosetting resin cured product is decomposed and dissolved by immersing the object to be treated in the treatment liquid.

5. The method of treating a thermosetting resin cured product according to claim 1, wherein the treatment liquid in the treatment step has a temperature of 100° C. or higher.

6. The method of treating a thermosetting resin cured product according to claim 1, wherein the thermosetting resin cured product comprises an epoxy resin cured product.

7. The method of treating a thermosetting resin cured product according to claim 1, wherein the thermosetting resin cured product comprises an acid anhydride-cured epoxy resin.

8. The method of treating a thermosetting resin cured product according to claim 1, wherein the alkali metal hydroxide comprises at least one selected from the group consisting of sodium hydroxide and potassium hydroxide.

9. The method of treating a thermosetting resin cured product according to claim 1, wherein the alcohol solvent comprises a solvent having a boiling point of 105° C. or higher at atmospheric pressure.

10. The method of treating a thermosetting resin cured product according to claim 1, wherein the alcohol solvent comprises benzyl alcohol.

11. The method of treating a thermosetting resin cured product according to claim 1, wherein the object to be treated further comprises an inorganic material.

12. The method of treating a thermosetting resin cured product according to claim 11, wherein the inorganic material comprises carbon fibers.

13. The method of treating a thermosetting resin cured product according to claim 11, further comprising a step of separating the inorganic material after the thermosetting resin cured product is decomposed and dissolved.
